(19) United States
(12) Patent Application Publication
(10) Pub. No.: US 2024/0060826 A1
(43) Pub. Date: Feb. 22, 2024

(54) TEMPERATURE-MONITORING DEVICE

(71) Applicant: HONDA MOTOR CO., LTD., Tokyo (JP)

(72) Inventors: Hirotaka Endo, Wako-shi, Saitama-ken (JP); Kojiro Takasu, Minato-ku, Tokyo (JP); Shigeki Edamatsu, Wako-shi, Saitama-ken (JP); Yuka Kuramochi, Minato-ku, Tokyo (JP)

(21) Appl. No.: 18/260,384

(22) PCT Filed: Jan. 6, 2021
(86) PCT No.: PCT/JP2021/000150

§ 371 Date: Jul. 5, 2023

(51) Int. Cl. G01K 3/00; H01M 10/48; H01M 10/42

(52) U.S. Cl. CPC G01K 3/005; H01M 10/486; H01M 10/4221; H02J 7/0047

(57) ABSTRACT

A management server, which is a temperature-monitoring device, monitors the temperature of a battery that is removably attached to an apparatus. The management server includes: a server-side acquisition unit that acquires the temperature of the battery when the battery is not in use after discharging electricity to the apparatus; and a determination process unit that performs a temperature determination process for determining whether or not the temperature while the battery is not in use is in a predetermined temperature range. The determination process unit excludes, from items on which the temperature determination process is to be performed, the temperature during an initial period from when the non-use of the battery has started to when a predetermined condition is satisfied.

### TECHNICAL FIELD

The present invention relates to a temperature monitoring device configured to monitor the temperature of a battery that is capable of being attached to and detached from equipment.

### BACKGROUND ART

In recent years, there has been provided a rental system (sharing system) for renting to a user a battery that is capable of being attached to and detached from equipment such as an electric working machine or an electric vehicle or the like (see, for example, JP 2017-045449 A). The system disclosed in JP 2017-045449 A transmits to a server device history information (a total discharge amount, a total charge amount, a number of times of charging, a number of times of discharging, a voltage, a current, an internal resistance, a temperature, etc.) of an electrical power storage device via an information terminal of the user, and by the server device, manages the state of the electrical power storage device that is being rented.

### SUMMARY OF THE INVENTION

Incidentally, since electric working machines and electric vehicles are basically used outdoors, the temperature during usage (during discharging) of the battery cannot avoid being influenced by the outdoor environmental temperature (i.e., a high temperature environment, a low temperature environment). On the other hand, in the case that discharging of the battery is stopped due to a break or the like (during non-usage thereof), the user can remove the battery and carry it indoors to a normal temperature environment (a location where the temperature is adjusted by cooling or heating).

Degradation of the battery can be suppressed simply by appropriately managing the temperature during non-usage of the battery. Accordingly, if the user is made aware that the battery during non-usage thereof should be placed on standby in a normal temperature environment, a long useful lifetime of the battery can be promoted, and it becomes possible to lower the cost of the system and the like.

The present invention has been made in view of the above circumstances, and has the object of providing a temperature monitoring device which, by monitoring with high accuracy the temperature of a battery during non-usage thereof, the user can be prompted to be made aware of the temperature management of the battery during non-usage of the battery.

In order to achieve the aforementioned object, one aspect of the present invention is characterized by a temperature monitoring device that monitors a temperature of a battery that is configured to be attached to and detached from equipment, the temperature monitoring device including an acquisition unit configured to acquire a temperature of the battery during non-usage after having carried out discharging to the equipment, and a determination processing unit configured to perform a temperature determination process in order to determine whether or not the temperature during non-usage lies within a predetermined temperature range, wherein the determination processing unit excludes, from being a target of the temperature determination process, the temperature of the battery in an initial period from a starting time of the non-usage until a predetermined condition is satisfied.

By accurately monitoring the temperature of the battery during non-usage thereof, the temperature monitoring device described above is capable of prompting the user to be made aware of the temperature management of the battery during non-usage of the battery.

### BRIEF DESCRIPTION OF DRAWINGS

FIG. 1 is an explanatory diagram showing an overall configuration of a sharing system to which a temperature monitoring device according to a first embodiment of the present invention is applied;

FIG. 2 is a flowchart showing a procedure for using the sharing system;

FIG. 3 is a block diagram showing functional units of a battery, a battery station, and a management server;

FIG. 4 is a perspective view showing a battery that is rented in the sharing system;

FIG. 5A is an explanatory diagram illustrating a pattern of acquiring a temperature of a battery during usage thereof;

FIG. 5B is an explanatory diagram illustrating a pattern of acquiring a temperature of a battery during non-usage thereof;

FIG. 6 is a table illustrating a battery database;

FIG. 7 is a graph for the purpose of illustrating a process of a determination processing unit according to the first embodiment with respect to changes in temperature during usage and during non-usage of the battery;

FIG. 8 is a table illustrating identity information of the present invention;

FIG. 9 is a flowchart showing operations of the sharing system according to the first embodiment;

FIG. 10 is a block diagram showing functional units of a battery, a battery station, and a management server to which a temperature monitoring device according to a second embodiment of the invention is applied;

FIG. 11 is a graph for the purpose of illustrating a process of a determination processing unit according to the second embodiment with respect to changes in temperature during usage and during non-usage of the battery;

FIG. 12 is a flowchart showing operations of the sharing system according to the second embodiment;

FIG. 13 is a block diagram showing functional units of a battery, a battery station, and a management server to which a temperature monitoring device according to a third embodiment of the invention is applied;

FIG. 14 is a table illustrating temperature map information; and

FIG. 15 is a graph for the purpose of illustrating a process of a determination processing unit according to the third embodiment with respect to changes in temperature during usage and during non-usage of the battery.

### DESCRIPTION OF THE INVENTION

Hereinafter, a description will be presented and described in detail below with reference to the accompanying drawings concerning an embodiment of the present invention.

### First Embodiment

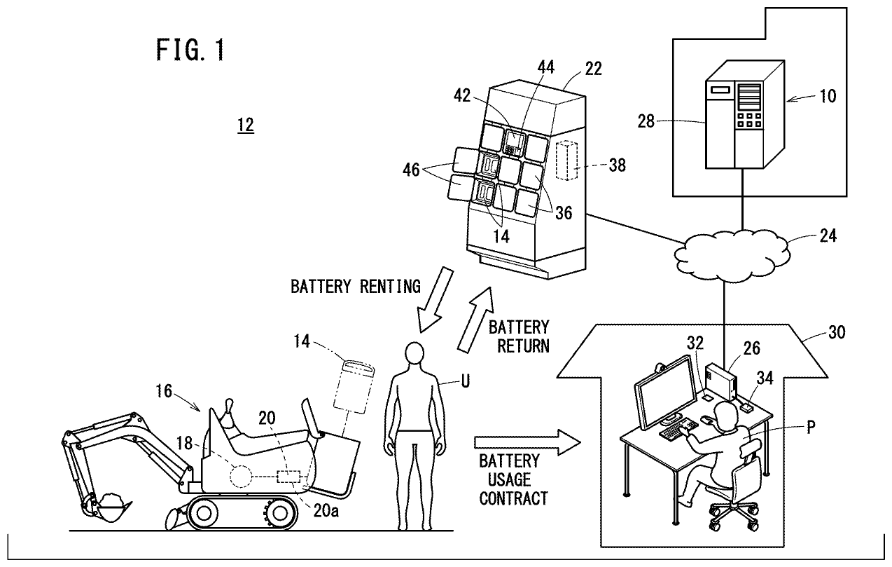

As shown in FIG. 1, a temperature monitoring device 10 according to a first aspect of the present invention is applied to a sharing system 12 in which batteries 14 are rented from a business operator to a plurality of users U. A user U, to whom a battery 14 has been rented in the sharing system 12, installs the battery 14 in equipment 16, and uses the equipment 16 based on the supply of electrical power from the battery 14. The term “user U” of the sharing system 12 indicates one individual user, and together therewith, may indicate a group of a plurality of individuals (a company, a group, or the like). Further, the sharing system 12 is not limited to being of a form in which the business operator rents batteries 14 to a user U, and may be of a form in which one or more batteries 14 are shared among a plurality of users U.

The battery 14 that is rented to the user U is a general purpose detachable type battery that is capable of being attached to and detached from various equipment 16. The equipment 16 of the user U may be possessed by the user U, or alternatively, may be rented separately from the battery 14. As examples of such equipment 16, there may be cited working machines (e.g., construction machinery, heavy machinery, industrial equipment, household equipment), and moving bodies (e.g., four-wheeled vehicles, two-wheeled vehicles, electric bicycles, carts, and robots) or the like. In FIG. 1, as the equipment 16, there is representatively illustrated an electric excavator which is operated by the supply of electrical power from the battery 14. The equipment 16 is equipped with a drive source 18 such as a motor or the like, an electrical component 20 including a control device 20a or the like, and operates by supplying electrical power to the drive source 18 or the electrical component 20 from the installed battery 14. Moreover, the equipment 16 may be constituted in a manner so as to be equipped with a battery unit (not shown) in order to drive the electrical component 20 with low electrical power at a time when the battery 14 is not installed.

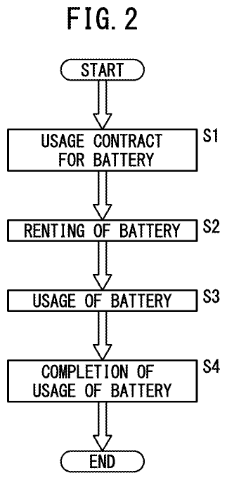

In this instance, in order to facilitate understanding of the present invention, a description will be given with reference to FIG. 2 concerning a procedure for using the sharing system 12 according to the present embodiment.

When using the sharing system 12, first, the user U first signs a usage contract for using the battery 14 with the business operator of the sharing system 12 (step S1). During a usage period in accordance with such a usage contract, the user U proceeds to an appropriate battery station 22 (refer to FIG. 1), and the battery 14 (step S2) is rented to the user U. The sharing system 12 may adopt a form in which the battery 14 that is rented to the user U from the battery station 22 (by way of leasing or rental) is used only by the user U, and is not shared with other users U.

Then, the user U installs the rented battery 14 in the equipment 16 and uses the equipment 16 (step S3). In the case that the residual battery level of the battery 14 during the usage period has become insufficient, the user U accommodates the battery 14 in the battery station 22 where it was received, or in a different battery station 22 from where it was received. Consequently, the battery station 22 carries out charging of the accommodated battery 14. In the case that usage of the battery 14 is continued, the battery station 22 rents a newly charged battery 14 on which charging is completed to the user U.

In the case that usage of the battery 14 is completed, after returning the battery 14 to the battery station 22, the user U terminates the usage contract by completing a usage termination procedure with the business operator of the sharing system 12 (step S4).

In order to carry out the above-described usage procedure, as shown in FIG. 1, the sharing system 12 is constructed as a client-server type of system by a business operator of the system using a network 24 such as the Internet or an intranet or the like. The sharing system 12 comprises, as devices connected to the network 24, a business operator terminal 26, a management server 28, and the above-described battery station 22. Alternatively, the battery 14 itself may possess a wireless communication function that enables connection to the network 24, and can be configured in a manner so as to carry out communication with the management server 28 while the user U is using or is standing by at the battery station 22. The management server 28 manages the state of renting or non-renting, and the residual battery level and the like of all the batteries 14 provided by the sharing system 12. Further, the management server 28 constitutes the temperature monitoring device 10 that monitors the temperature of the batteries 14 (specifically, the temperature of battery cell main bodies 52, which will be described later).

The business operator of the sharing system 12 is equipped with a business operator facility 30 that the user U visits when signing the contract to use the batteries 14. The business operator terminal 26, which is operated by a person in charge P on the side of the business operator, is installed in the business operator facility 30. For example, the business operator terminal 26 is a computer (a desktop computer, a laptop computer) that is capable of communicating via the network 24. An information processing terminal such as a PDA, a tablet, a smart phone, a mobile phone, or a wearable computer or the like may also be applied to the business operator terminal 26. Further, the business operator may carry the business operator terminal 26 and thereby conduct business, and the business operator need not necessarily be equipped with the business operator facility 30.

The business operator assigns user identification information (hereinafter referred to as a user ID) to the user U who has signed the usage contract. The user ID is specified by the user U or is automatically assigned by the business operator, and by being transmitted to the management server 28 via the business operator terminal 26, the user ID is managed by the business operator terminal 26 and the management server 28. Further, the business operator facility 30 includes an IC card 32 with an embedded RF tag, and a writer 34 connected to the business operator terminal 26 and by which information is written to the IC card 32. The business operator issues the IC card 32, in which information including the user ID is stored, to the user U who has signed the usage contract.

The battery station 22 is a shelf-shaped accommodating device in which a plurality of slots 36 in which the batteries 14 can be accommodated are arranged in a matrix, and for example, is installed outside of the business operator facility 30. The battery station 22 includes a function as a charging device that carries out charging of the battery 14 when the battery 14 is accommodated therein by the user U or the person in charge P on the side of the business operator, and a function as an exchange device that enables the battery to be exchanged with another battery 14. Moreover, it should be noted that battery stations 22 are more preferably installed at various locations within the city. The battery station 22 may also be temporarily installed, for example, at a location (a work site) where work is performed by the equipment 16.

The battery station 22 has a computer (a rental control unit 38) including one or more processors, a memory, an input/output interface, and a timer, none of which are shown, and is configured to be capable of communicating with the management server 28. On the outer surface of the battery station 22, there are provided a touch panel 42 (a display operation unit) or another operation unit that displays an image under the control of the rental control unit 38, and recognizes image operations of the user U, and a reader 44 (an input unit) for reading information of the IC card 32 of the user U. Furthermore, each of the respective slots 36 of the battery station 22 includes a non-illustrated communication module that carries out communication of information with the battery 14 accommodated therein, and a battery locking mechanism 46 that switches between a removal-allowed state and a removal-disabled state of the battery 14.

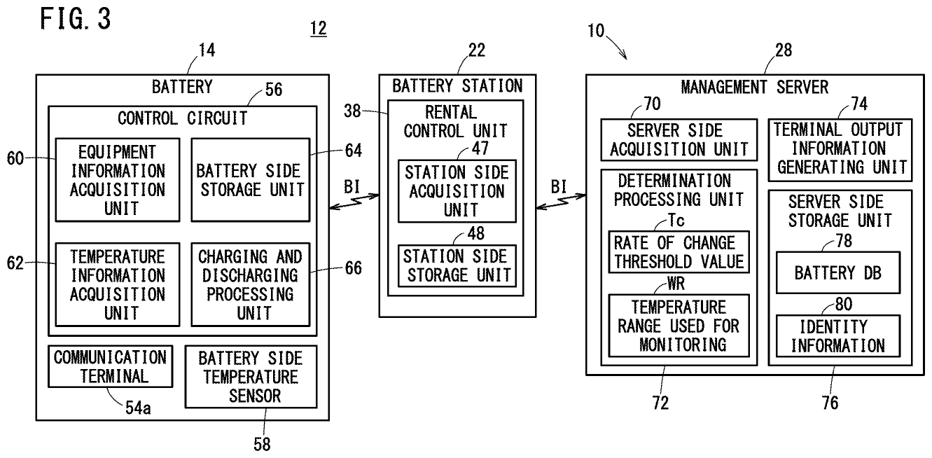

As shown in FIG. 3, by one or more processors executing a program stored in the memory, the rental control unit 38 of the battery station 22 has formed therein a station side acquisition unit 47 and a station side storage unit 48. When battery information BI is acquired from the battery 14 via the communication module, the station side acquisition unit 47 temporarily stores the battery information BI in the station side storage unit 48, and furthermore, automatically transmits the acquired battery information BI to the management server 28. The battery information BI will be described in detail later.

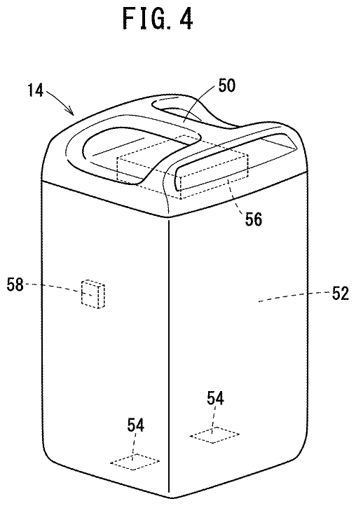

As shown for example in FIG. 4, the battery 14 that is rented to the user U is generally formed in a prismatic shape, and has a handle 50 at one end in order for the user U to grasp. Further, the battery 14 includes the battery cell main body 52 that actually stores and discharges electrical power, a plurality of terminals 54 that are capable of inputting and outputting electrical power, a control circuit 56 that controls charging and discharging of the battery 14, and a battery side temperature sensor 58 for detecting the temperature of the battery 14.

The battery cell main body 52 is configured in a manner so as to include an appropriate output voltage, a battery capacity, and the like, by connecting a plurality of the battery cells (not shown) such as liquid batteries or all solid state batteries or the like. The plurality of terminals 54 are provided, for example, on an opposite side (or the same side) as the handle 50, and when installed in the equipment 16, the battery 14 is placed in contact with non-illustrated equipment side terminals, and together therewith, when accommodated in the battery station 22, the battery 14 is placed in contact with non-illustrated battery station side terminals. At least one from among the plurality of terminals 54 functions as a communication terminal 54a (refer to FIG. 3) that is capable of communicating information with the control device 20a of the equipment 16.

The battery side temperature sensor 58 detects the temperature of the battery cell main body 52 based on a request from the control circuit 56, and transmits the detected temperature to the control circuit 56. For example, the battery side temperature sensor 58 is provided on a side surface of a casing at a center (the center in a stacking direction of the battery cells of the battery cell main body 52) of the battery 14 in the longitudinal direction. Moreover, it is a matter of course that the installation position of the battery side temperature sensor 58 is not particularly limited.

The control circuit 56 is configured in the form of a computer including one or more processors, a memory, an input/output interface, and a timer or the like, none of which are shown. By the processor executing a non-illustrated program stored in the memory, the control circuit 56 forms functional blocks as shown in FIG. 3.

As shown in FIG. 3, in the control circuit 56, there are formed an equipment information acquisition unit 60, a temperature information acquisition unit 62, a battery side storage unit 64, and a charging and discharging processing unit 66. The equipment information acquisition unit 60, in a state in which the battery 14 is installed with respect to the equipment 16, acquires equipment information from the equipment 16, and stores the equipment information in the battery side storage unit 64. As examples of the equipment information, there may be cited equipment identification information (hereinafter referred to as an equipment ID) which is unique identification information in order to identify the equipment 16, a required electrical power (or a required voltage and a required current), and the like.

When the equipment ID is stored in the battery side storage unit 64, the equipment information acquisition unit 60 stores in association with each other the time measured by the timer and the equipment ID. For example, by associating with each other the time at which the battery 14 was installed in the equipment 16 and the equipment ID, the equipment information acquisition unit 60 stores in the equipment 16 an installation starting time at which installation of the battery was started. Further, for example, by associating with each other the time at which the battery 14 was taken out from the equipment 16 (the equipment ID is no longer recognized) and the equipment ID, the equipment information acquisition unit 60 stores in the equipment 16 an installation ending time at which installation of the battery was completed. Moreover, in the case that the required electrical power is stored, the equipment information acquisition unit 60 stores in association with each other the time and the required electrical power.

The temperature information acquisition unit 62 periodically acquires the detected temperature of the battery side temperature sensor 58, and associates the time measured by the timer with the detected temperature and stores them in the battery side storage unit 64. Regardless of whether it is during usage (a state in which charging or discharging is carried out) or during non-usage (a state in which charging or discharging is stopped) of the battery 14 with respect to the equipment 16, the temperature information acquisition unit 62 acquires the temperature and stores the temperature in the battery side storage unit 64. However, the temperature information acquisition unit 62 makes the interval at which the detected temperature is acquired during usage of the battery 14 shorter than the interval at which the detected temperature is acquired during non-usage of the battery 14. For example, the temperature information acquisition unit 62 stores the detected temperature at an interval of one minute or less (10 seconds, 30 seconds, 60 seconds, etc.) during usage of the battery 14, while on the other hand, stores the detected temperature at an interval of three minutes or more (3 minutes, 5 minutes, 10 minutes, etc.) during non-usage of the battery 14.

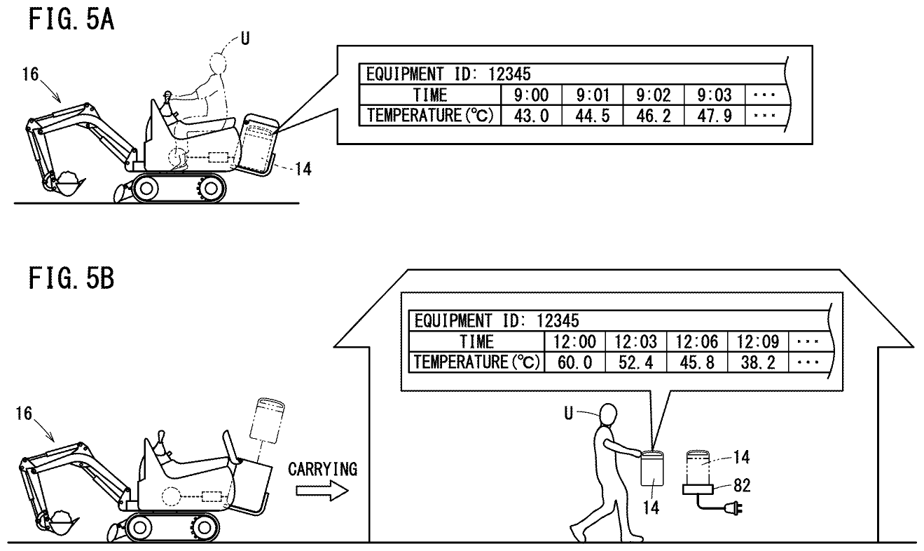

Specifically, as shown in FIG. 5A, in the case that the equipment 16 is operating outdoors, the temperature of the battery 14 receives an influence and changes under the influence of the outdoor environmental temperature, the heat of the equipment 16, and the heat accompanying discharging of the battery 14 itself. Therefore, in an installed state of the battery 14 with respect to the equipment 16, together with the equipment ID (and the installation starting time and the installation ending time), the control circuit 56 stores the temperature information, which is time-series data in which the detected temperature of the battery side temperature sensor 58 and the time are associated with each other. As one example, in the case that the battery 14 is installed in the equipment 16 in an environment where the outdoor temperature is greater than or equal to 40° C., there is a possibility that the temperature of the battery 14 may become a high temperature (for example, greater than or equal to 60° C.). Further, in the case that the battery 14 is installed in the equipment 16 in an environment where the outdoor temperature is less than or equal to 0° C., there is a possibility that the battery 14 is continued to be used while the temperature of the battery 14 may become a low temperature (for example, less than or equal to 5° C.).

On the other hand, as shown in FIG. 5B, a situation may be considered in which the user U interrupts work in order to take a break or the like, and has carried the battery 14 indoors where the temperature is adjusted to a normal temperature environment (for example, a temperature range of 15° C. to 30° C.). In this case, the temperature of the battery 14 receives an influence of the indoor room temperature environment, and undergoes a change toward the indoor temperature. For example, even in the case that the battery 14 was used in an outdoor environment with an outdoor environmental temperature of greater than or equal to 40° C. or less than or equal to 0° C., by the battery 14 being carried indoors, the temperature of the battery 14 is adjusted to the normal temperature environment.

During a period in which discharging from the battery 14 to the equipment 16 is being carried out, it is unavoidable that the battery 14 will receive an influence of the outdoor environmental temperature or the like. However, the user U is capable of carrying and storing the battery 14 indoors during non-usage of the battery 14. By storing the battery 14 at an appropriate temperature even during non-usage thereof, deterioration of the battery can be suppressed. Therefore, by extracting the temperature of the battery 14 during non-usage thereof, and determining whether or not the battery 14 has been stored in a normal temperature environment, the sharing system 12 prompts the user U to be made aware of an appropriate temperature management of the battery 14.

Returning to FIG. 3, the charging and discharging processing unit 66 of the battery 14 controls the electrical power of the battery 14 that is discharged (supplied) to the equipment 16 based on the electrical power required by the equipment 16. Further, in the case that the battery 14 is attached to the charging device, the charging and discharging processing unit 66 controls the amount of electrical power and the charging speed at which the electrical power is charged to the battery cell main body 52. The control circuit 56 preferably stores in the battery side storage unit 64 discharging information associated with the discharged electrical power and the time period during which discharging takes place with respect to the equipment 16, and together therewith, stores in the battery side storage unit 64 charging information associated with the charged electrical power and the time period during which charging from the charging device takes place. In the present embodiment, the charging and discharging information refers to information that includes the discharging information and the charging information.

The charging and discharging processing unit 66 may execute an equipment authentication process to determine whether or not the equipment 16 used by the user U is authorized based on the equipment ID acquired by the equipment information acquisition unit 60. For example, by storing in the battery side storage unit 64 the equipment ID (a registration ID) of at least one of the equipment 16 used by the user U, the charging and discharging processing unit 66 is capable of executing the device authentication at a time when the battery 14 is installed with respect to the equipment 16. The registration ID may be stored by the battery station 22 at the time when the battery 14 is rented to the user U. In addition, the charging and discharging processing unit 66 carries out discharging to the equipment 16 in the case that the equipment 16 is determined to be legitimate equipment by way of equipment authentication, and prohibits discharging to the equipment 16 in the case that the equipment 16 is determined not to be legitimate equipment by way of equipment authentication.

In accordance with the process described above, in the battery side storage unit 64, there are stored the equipment ID associated with the installation starting time and the installation ending time, time-series data of the detected temperature (temperature information), time-series data of the discharged electrical power (discharging information), and time-series data of the charged electrical power (charging information), the registration ID, and the like.

During usage of the battery 14 (in step S3 in FIG. 2), the user U accommodates (returns) the battery 14 to the battery station 22 when the residual battery level of the battery 14 becomes low. From the battery 14 that is accommodated in the slot 36, the station side acquisition unit 47 of the rental control unit 38 acquires the battery information BI that is stored in the battery side storage unit 64. As the battery information BI that is acquired by the rental control unit 38, there may be cited identification information unique to the battery 14 (hereinafter referred to as a battery ID), a residual battery level, the equipment ID associated with the installation starting time and the installation ending time, temperature information, charging and discharging information, and the like.

Upon acquiring the battery information BI, the rental control unit 38 temporarily stores the battery information BI in the station side storage unit 48, and carries out charging of the battery 14 based on the acquired residual battery level. Furthermore, the rental control unit 38 automatically transmits the battery information BI to the management server 28. The management server 28 receives the battery information BI, and analyzes the temperature of the battery 14 during non-usage thereof.

The management server 28 is configured in the form of a computer including one or more processors, a memory, an input/output interface, and a timer or the like, none of which are shown. The management server 28, by causing the processor to execute a non-illustrated program that is stored in the memory, has formed therein a server side acquisition unit 70, a determination processing unit 72, a terminal output information generating unit 74, and a server side storage unit 76.

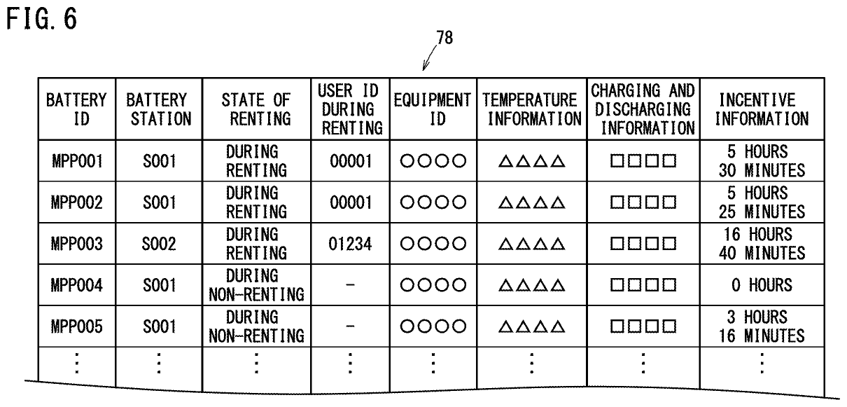

After having acquired the battery information BI from the battery station 22, as shown in FIG. 6, the server side acquisition unit 70 stores the battery information BI in a battery database 78 (hereinafter referred to as a battery DB 78) that is stored in the server side storage unit 76. For example, in the battery DB 78, there are included the battery ID, a code (or a current position) of the battery station 22 to which the battery belongs, a rental status such as during rental or during non-rental, a user ID of the user during rental, the acquired battery information BI (the equipment ID including the installation starting time and the installation ending time, the temperature information, and the charging and discharging information, etc.), and later-described incentive information, and the like.

The determination processing unit 72 reads out the battery DB 78 at an appropriate timing, and monitors the temperature management of the battery 14 for each of the batteries 14. Hereinafter, a description will be given in detail concerning the process of the determination processing unit 72 according to the first embodiment. Moreover, hereinafter, although a case in which the indoor environmental temperature is high (for example, 40° C.) is shown as an example, it is a matter of course that the determination processing unit 72 is capable of executing the same process, even in the case that the indoor environmental temperature is of a lower temperature.

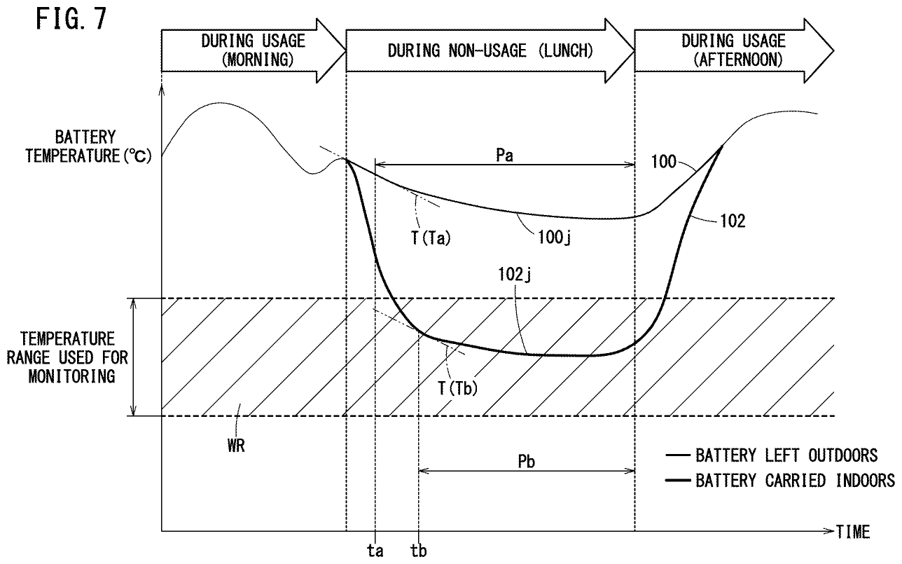

As shown in FIG. 7, when the equipment 16 is used outdoors, the temperature of the battery 14 reaches a high temperature of greater than or equal to 60° C. In particular, in the case that the discharged electrical power from the battery 14 to the equipment 16 is large, the temperature of the battery 14 rapidly becomes high in temperature. The temperature information acquisition unit 62 of the battery 14 stores in the battery side storage unit 64 the temperature detected by the battery side temperature sensor 58. By taking a break or the like, when the user U interrupts the work, the battery 14 stops discharging and enters into a state of non-usage. The battery 14, which has been at a high temperature, gradually dissipates heat, and the temperature of the battery undergoes a change so as to approach the environmental temperature.

In this instance, in a situation in which the battery 14 is left outdoors during non-usage thereof, the temperature of the battery 14 gradually decreases toward the outdoor environmental temperature (40° C.) (hereinafter, referred to as an outdoor standby temperature 100). In addition, the outdoor standby temperature 100 of the battery 14 during non-usage thereof changes in a substantially constant manner in the vicinity of the outdoor environmental temperature.

On the other hand, in a situation in which the user U has carried the battery 14 indoors during non-usage thereof, the temperature of the battery 14 decreases rapidly toward the temperature (hereinafter, referred to as an indoor standby temperature 102) that is adjusted in temperature to the indoor temperature (to the normal temperature environment: 25° C., for example). In addition, the indoor standby temperature 102 of the battery 14 during non-usage thereof changes in a substantially constant manner in the vicinity of the indoor normal environmental temperature.

More specifically, the rate of change T in the temperature of the battery 14 per hour differs between the situation in which the battery 14 is left outdoors and the situation in which the battery 14 is carried indoors. The determination processing unit 72 calculates the rate of change T in the temperature during non-usage based on the temperature information (time-series data of the detected temperature) for each of the batteries 14, and compares the calculated rates of change T with a previously stored threshold value for the rate of change threshold value Tc (refer to FIG. 3). Although the rate of change threshold value Tc is not particularly limited, the threshold value Tc is set, for example, to a value at which the temperature of the battery 14 changes by ±1° C. in three minutes.

In the case that the rate of change T of the temperature of the battery 14 from the starting time of non-usage exceeds the rate of change threshold value Tc, concerning such a period (an initial period), the determination processing unit 72 performs an initial period exclusion process so that the initial period is excluded from being included in the temperatures used in order to analyze the temperature management of the battery 14. This is because, in the case that the rate of change T of the temperature during non-usage exceeds the rate of change threshold value Tc, it cannot be determined whether the battery 14 is present in either one of being outdoors or indoors. Stated otherwise, concerning the initial period at the starting time of non-usage, if such an initial period is included as an object for the purpose of determining the temperature management for the user U, since in most cases, the period will be far away from the normal temperature environment, the data will not be able to provide high satisfaction to the user U.

In addition, as the temperature for monitoring the storage state of the battery 14, the determination processing unit 72 extracts the temperature from a point in time at which the rate of change T in the temperature during non-usage becomes less than or equal to the rate of change threshold value Tc. For example, in a situation in which the battery 14 is left outdoors, since the temperature of the battery 14 decreases gradually, the rate of change Ta of the temperature during non-usage (the outdoor standby temperature 100) becomes less than or equal to the rate of change threshold value Tc at a faster timing (at the point of time ta shown in FIG. 7). Consequently, the determination processing unit 72 uses the temperature of the battery 14 that gradually approaches toward the outdoor environmental temperature in a period (a determination detection period Pa) during non-usage after the point in time ta, as a temperature (hereinafter, also referred to as a detection temperature 100j used for determination) used for making a determination.

Further, the determination processing unit 72 includes information of a temperature range WR (a predetermined temperature range) used for monitoring in which the deterioration of the battery 14 is suppressed, and determines whether or not the detection temperature 100j used for determination that is extracted lies within the temperature range WR used for monitoring. The temperature range WR used for monitoring is preferably set to an appropriate range in accordance with the temperature characteristics of the battery 14. Further, a previously fixed upper limit value and lower limit value may be applied to the temperature range WR used for monitoring. According to the present embodiment, the temperature range WR used for monitoring is set to the aforementioned 15° C. to 30° C. range (the normal temperature environment). Further, the management server 28 can be configured to acquire the outdoor atmospheric temperature, and change the temperature range WR (the upper limit value and the lower limit value) used for monitoring based on the atmospheric temperature. The outdoor atmospheric temperature may be received from the battery station 22 (refer to the second embodiment, to be described later), or may be received from the server of a service company that provides the atmospheric temperature. The temperature range WR used for monitoring may also be set in accordance with the season such as spring, summer, autumn, and winter.

The outdoor standby temperature 100 of the battery 14 that is left outdoors approaches toward the outdoor environmental temperature after the point in time ta (the determination detection period Pa), and therefore, is always in excess of the temperature range WR used for monitoring. Accordingly, the determination processing unit 72 determines that the detection temperature 100j used for determination is not included within the temperature range WR used for monitoring. Stated otherwise, the determination processing unit 72 is capable of recognizing that the battery 14 has been left outdoors by the user U.

Conversely, in a situation in which the battery 14 is carried indoors, since the temperature of the battery 14 decreases rapidly, at a later timing (the point in time tb shown in FIG. 7), the rate of change Tb in the temperature during non-usage becomes less than or equal to the rate of change threshold value Tc. The determination processing unit 72 uses the indoor standby temperature 102 of the battery 14, which has approached toward the indoor temperature (25° C.) after the point in time tb (the determination detection period Pb), as a detection temperature 102j used for determination. Therefore, after the point in time tb, the determination processing unit 72 determines that the detection temperature 102j used for determination is included within the temperature range WR used for monitoring.

In this manner, after the point in time tb, if the detection temperature 102j used for determination after time tb is included within the temperature range WR used for monitoring, it can be accurately recognized that the user U has carried the battery 14 indoors. Further, the determination processing unit 72 performs a temperature determination process for determining whether or not the detection temperature 102j used for determination is always included within the temperature range WR used for monitoring during non-usage after the point in time tb. The period during non-usage of the battery 14 can be determined by the installation starting time and the installation ending time that are associated with the equipment ID of the battery information BI, or the discharge starting time and the discharge ending time included within the discharging information. Alternatively, the determination processing unit 72 may determine that the non-usage period has ended, based on the rate of change T when the temperature of the battery 14 rises (or drops) rapidly.

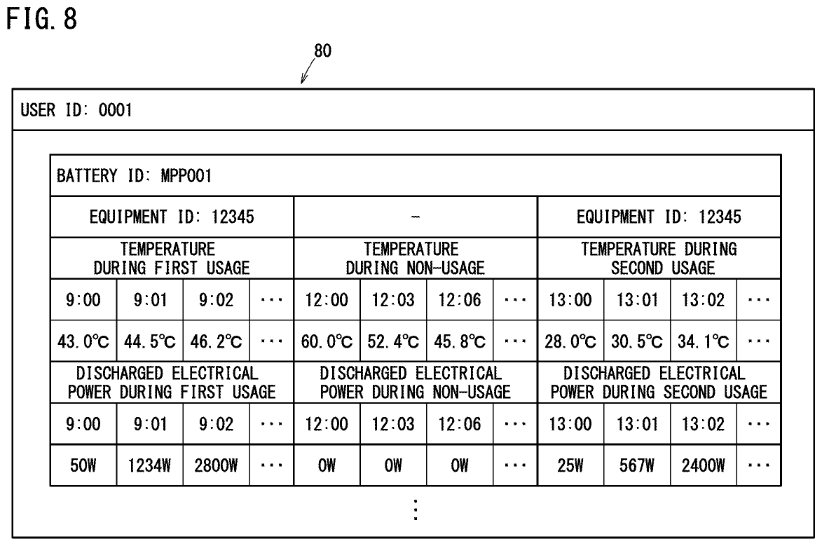

In the initial period exclusion process and the temperature determination process, as shown in FIG. 8, on the basis of the battery ID, the equipment ID, and the user ID and the like that are stored in the battery DB 78, the determination processing unit 72 preferably generates identity information 80 of the battery 14 that is being used by the user U. For example, the identity information 80 is information that associates with each other a during first usage temperature information and the discharging information with respect to the same equipment ID on which discharging was carried out in a time band prior to non-usage, the temperature information and the discharging information during non-usage, and a during second usage temperature information and discharge information on which discharging was carried out in a time band after non-usage.

By associating respectively with each other the during first usage temperature information and the discharging information, the temperature information and the discharging information during non-usage, and the during second usage temperature information and the discharging information, the determination processing unit 72 becomes capable of accurately distinguishing between the starting time and the ending time of non-usage. Further, by associating with each other the user ID of the user U who is using the equipment 16 and the device ID, the identity information 80 is capable of encompassing the temperature information over the entirety of one or more of the batteries 14 that are used by the user U.

After the detection temperature 102j used for determination has temporarily entered into the temperature range WR used for monitoring, in the case that the detection temperature 102j used for determination is always included within the temperature range WR used for monitoring during the period of non-usage, then concerning such a battery 14, the determination processing unit 72 certifies it as being an object that provides an incentive. In addition, the period during which the detection temperature 102j used for determination was included within the temperature range WR used for monitoring is added to the incentive information in the battery DB 78 (refer also to FIG. 6). When the battery 14 is taken outdoors in order to be used after non-usage thereof, although the temperature of the battery rises (or falls) so as to approach toward the outdoor environmental temperature, by setting the temperature range WR used for monitoring with a certain degree of width in addition to the temperature range of the normal temperature environment (for example, ±10° C. of the normal temperature environment), the satisfaction of the user U can be enhanced. Moreover, during non-usage thereof, after having entered temporarily within the temperature range WR used for monitoring, in the case that the temperature of the battery 14 has fallen outside of the temperature range WR used for monitoring, it can be assumed that the user U has carried the battery 14 outdoors without the intention of using it. Therefore, concerning such a battery 14, the determination processing unit 72 determines not to provide the incentive.

Returning to FIG. 3, at the time when the user U has concluded the usage contract for using the battery 14, the terminal output information generating unit 74 calculates an incentive value (a discount of the usage fee, a provision of points, or the like) in accordance with the accumulated period in the incentive information. The terminal output information generating unit 74 refers to the identity information 80 of the user U, and calculates the incentive value of the entirety of one or more batteries 14 that are used by the user U during the usage period. In addition, the terminal output information generating unit 74 transmits settlement information for termination of the usage contract to the business operator terminal 26. In addition to the incentive value, the storage situation of the battery 14 by the user U (an average value of the temperature information of the battery 14, and the like) may be appended to the settlement information. The person in charge P who has confirmed the settlement information on the business operator terminal 26 can present to the user U the incentive described in the settlement information.

Moreover, in the case that the user U is receiving a rental (leasing or renting) of a charging device 82, or alternatively, owns such a charging device, it is conceivable that the user U may accommodate the battery 14 during interruption of work in the charging device 82 (see FIG. 5B) and carry out charging thereof. The temperature of the battery 14 becomes higher during the time of charging. Therefore, the determination processing unit 72 may be configured in a manner so as to cause the rate of change threshold value Tc to be changed when the charging period (the charging starting time and the charging ending time) of the charging information is extracted. Specifically, in the case that the determination processing unit 72 has extracted the fact that the battery 14 is in the charging period, the determination processing unit 72 increases the rate of change threshold value Tc during the charging period more than the rate of change threshold value Tc during non-charging (for example, a value is set such that the temperature of the battery 14 changes ±3° C. in 3 minutes). In accordance with this feature, during charging of the battery 14, the determination processing unit 72 is capable of hastening the timing at which the rate of change T in the temperature during non-usage becomes less than or equal to the rate of change threshold value Tc, or stated otherwise, the completion of excluding the initial period (starting of the determination detection period). Accordingly, even in the case that the battery 14 is charged indoors, it becomes possible to appropriately extract the detection temperatures 100j and 102j used for determination.

The sharing system 12 according to the first embodiment is basically configured in the manner described above. Hereinafter, a description will be given in detail concerning operations of the sharing system 12. Moreover, in the following, as a representative example of using the battery 14 that is installed in the equipment 16, a description will be given of a case in which, after work is carried out in the morning (during a first usage), a break is taken for lunch (during non-usage), and in the afternoon, work is performed again (during a second usage).

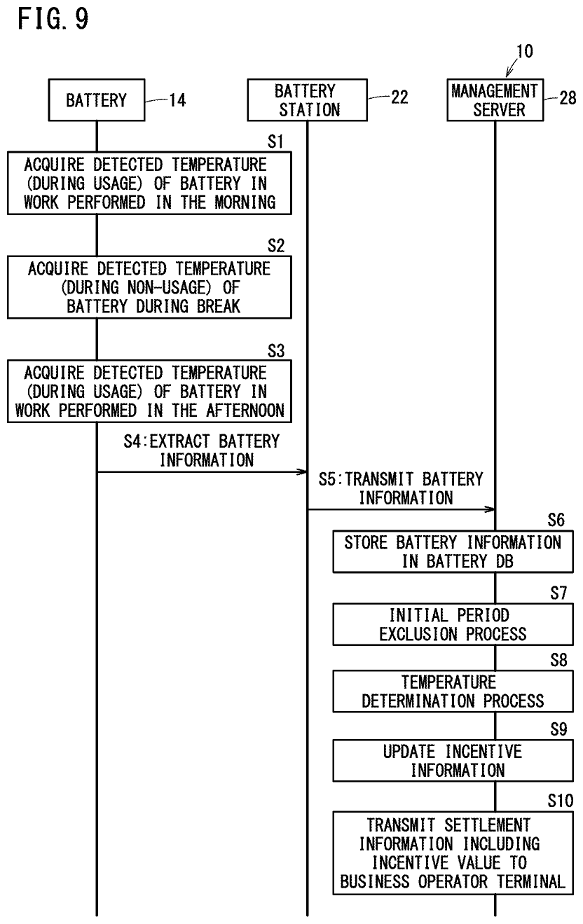

In this case, as shown in FIG. 9, the temperature information acquisition unit 62 of the battery 14 acquires the detected temperature of the battery 14 (the temperature during usage) at the time when work is performed in the morning, and stores the detected temperature in the battery side storage unit 64 in a state of being associated with the time (step S1). Next, the temperature information acquisition unit 62 of the battery 14 acquires the detected temperature of the battery 14 (the temperature during non-usage) at the time during taking a break, and stores the detected temperature in the battery side storage unit 64 in a state of being associated with the time (step S2). Furthermore, the temperature information acquisition unit 62 of the battery 14 acquires the detected temperature of the battery 14 (the temperature during usage) at the time when work is performed in the afternoon, and stores the detected temperature in the battery side storage unit 64 in a state of being associated with the time (step S3).

When the work in the afternoon is completed, the user U accommodates (returns) the battery 14 to the battery station 22. At the time when the battery 14 is accommodated, the rental control unit 38 of the battery station 22 extracts the battery information BI that is stored in the battery side storage unit 64 (step S4). In addition, the rental control unit 38 transmits the extracted battery information BI to the management server 28 (step S5). The server side acquisition unit 70 of the management server 28 stores the received battery information BI in respective fields of the battery DB 78 (step S6).

Furthermore, the determination processing unit 72 of the management server 28 reads out the battery DB 78, and in relation to each of the batteries 14, confirms the storage temperature of the battery 14 by the user U. First, concerning the temperature of the battery 14 during non-usage thereof, on the basis of the temperature information (time-series data of the temperature and the time), the determination processing unit 72 performs the initial period exclusion process to omit the initial period from the starting time of non-usage (step S7). In a situation in which the battery 14 is left outdoors, since the rate of change Ta in the temperature of the battery 14 (the outdoor standby temperature 100) is small, although the rate of change Ta of the temperature during non-usage quickly arrives at a value of less than or equal to the rate of change threshold value Tc, at that time, the determination processing unit 72 extracts the detection temperature 100j used for determination in the determination detection period Pa in which the initial period until the rate of change Ta of the temperature during non-usage reaches the rate of change threshold value Tc is excluded (refer to FIG. 7). On the other hand, in a situation in which the battery 14 is carried indoors, since the rate of change in the temperature of the battery 14 (the indoor standby temperature 102) is large, although the rate of change Tb of the temperature during non-usage slowly arrives at a value of less than or equal to the rate of change threshold value Tc, at that time, the determination processing unit 72 extracts the detection temperature 102j used for determination in the determination detection period Pb in which the initial period until the rate of change Tb of the temperature during non-usage reaches the rate of change threshold value Tc is excluded (refer to FIG. 7). Moreover, in the foregoing, although a case is assumed in which the outdoor environmental temperature (for example, 40° C.) is higher in comparison with the indoor environmental temperature (for example, 25° C.), in the case that the outdoor environmental temperature (for example, −5° C.) is lower in comparison with the indoor environmental temperature (for example, 25° C.), in a situation in which the battery 14 is left outdoors, the rate of change in the temperature of the battery 14 from the temperature of the battery 14 during usage of the battery (for example, 60° C.) becomes greater, while on the other hand, in a situation in which the battery 14 is carried indoors, since the rate of change in the temperature of the battery 14 becomes smaller, in a following manner, the temperature should be read and interpreted accordingly.

Next, during non-usage, the determination processing unit 72 carries out the temperature determination process to determine whether or not the extracted detection temperatures 100j and 102j used for determination are included within the temperature range WR used for monitoring (step S8). In addition, in the case that the detection temperature 102j used for determination is included within the temperature range WR used for monitoring, a determination is made that the battery 14 has been appropriately stored by the user U. Conversely, in the case that the detection temperature 100j used for determination is outside of the temperature range WR used for monitoring, a determination is made that the battery 14 has not been appropriately stored by the user U.

In addition, in the case that the detection temperature 102j used for determination is included within the temperature range WR used for monitoring, the determination processing unit 72 adds such a period as an incentive period, and updates the incentive information in the battery DB 78 (step S9).

When the user U visits the business operator facility 30 at a time when the usage contract is completed, under an operation of the person in charge P, settlement information in which the incentive value is included is transmitted from the management server 28 (the terminal output information generating unit 74) to the business operator terminal 26 (step S10). Consequently, for example, the person in charge P presents to the user U a service (a discounted fee or the like) in which the incentive is provided, and the user U can make the settlement at such a fee (or in the case that the usage fee has been paid in advance, return of cash or points can be awarded).

The present invention is not limited to the above-described embodiment, and various modifications are possible in line with the essence and gist of the invention. For example, the temperature monitoring device 10 is not limited to being applied to the management server 28, and may be provided in the battery station 22 or the charging device 82 that serves as the accommodation device for the batteries 14.

### Second Embodiment

Next, a description will be given concerning the configuration of a temperature monitoring device 10A (a sharing system 12A) according to a second embodiment. Moreover, in the following description, it should be noted that constituent elements having the same configuration or the same function as those in the above-described embodiment will be designated using the same reference numerals, and detailed description of such features will be omitted.

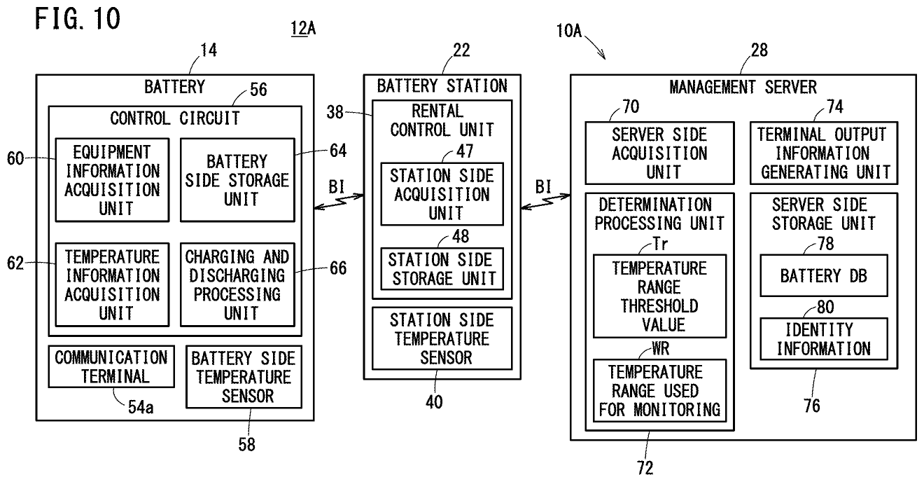

As shown in FIG. 10, the temperature monitoring device 10A according to the second embodiment differs from the temperature monitoring device 10 according to the first embodiment, in that a station side temperature sensor 40 is provided in the battery station 22. The station side temperature sensor 40 detects the temperature in the location where the battery station 22 is installed, namely, the outdoor environmental temperature (outside air temperature). Moreover, the station side temperature sensor 40 may detect as the environmental temperature the temperature inside the slot 36 in which the battery 14 is accommodated.

The rental control unit 38 of the battery station 22 associates with each other the outdoor environmental temperature detected by the station side temperature sensor 40 and the time, and stores them in the station side storage unit 48. Further, the rental control unit 38 transmits the environmental information (time-series data of the outdoor environmental temperature) to the management server 28 at an appropriate timing.

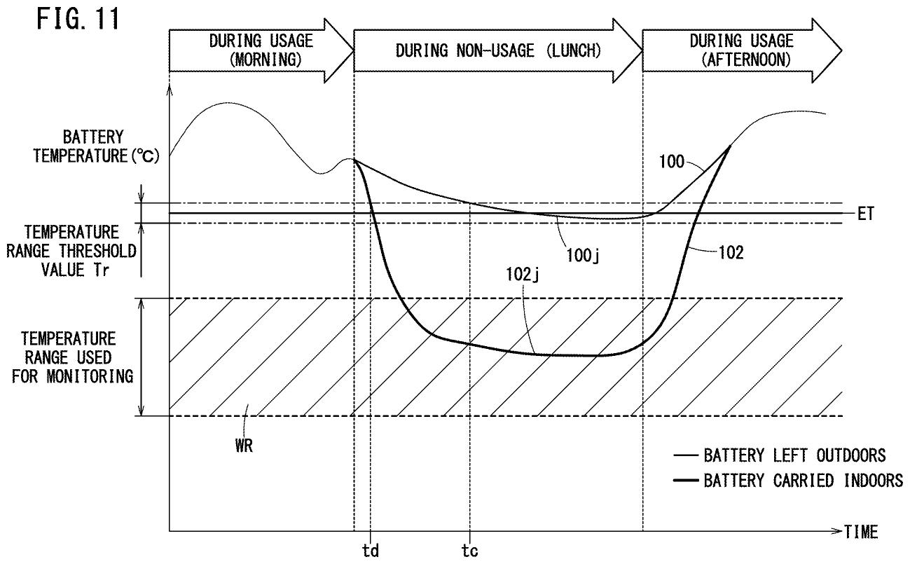

Upon receiving the environmental information, the server side acquisition unit 70 of the management server 28 stores the environmental information in the server side storage unit 76. In addition, the determination processing unit 72 of the management server 28 executes the initial period exclusion process on the basis of the stored environmental information. Specifically, the determination processing unit 72 recognizes the starting time of non-usage based on the battery information BI (the installation ending time, the discharge ending time, etc.) for each of the batteries 14, and extracts the environmental temperature ET associated with the starting time of non-usage from the environmental information of the battery station 22 to which the battery 14 belongs. As one example, as shown in FIG. 11, in the case that the starting time of non-usage of the battery 14 is exactly 12:00 o'clock, the determination processing unit 72 extracts the environmental temperature ET (for example, 40° C.) at 12:00 o'clock, of the battery station 22 to which the battery 14 belongs.

Furthermore, by adding a tolerance value (for example, ±1° C.) to the outdoor environmental temperature ET at the starting time of non-usage, the determination processing unit 72 uses a temperature range threshold value Tr in order to determine the detection temperature used for determination of the battery 14. For example, in the case that the outdoor environmental temperature ET is 40° C., the temperature range threshold value Tr, which has an upper limit value of 41° C. and a lower limit value of 39° C., is set. Moreover, it is a matter of course that the tolerance value is not limited to being ±1° C. The determination processing unit 72 sets as the determination detection period the period during non-usage from after the timing when the temperature during non-usage of the battery 14 has passed within the temperature range threshold value Tr until the next discharge is initiated, and extracts the detection temperatures 100j and 102j used for determination during the relevant period.

In this instance, in a situation in which the battery 14 is left outdoors during non-usage thereof, the temperature (the outdoor standby temperature 100) of the battery 14 gradually decreases toward the outdoor environmental temperature ET (40° C.). Accordingly, at a relatively later timing (the point in time tc shown in FIG. 11) when the outdoor standby temperature 100 of the battery 14 has approached toward the environmental temperature ET, the outdoor standby temperature 100 passes within the temperature range threshold value Tr (becomes less than or equal to the upper limit value of the temperature range threshold value Tr). Consequently, the determination processing unit 72 uses, as the detection temperature 100j used for determination, the outdoor standby temperature 100 of the battery 14, which is roughly constant along with the outdoor environmental temperature ET after the point in time tc.

In addition, in the case that the battery 14 is left outdoors, the detection temperature 100j used for determination exceeds the temperature range WR (15° C. to 30° C.) used for monitoring. Accordingly, over the entirety of the period during non-usage, the determination processing unit 72 determines that the detection temperature 100j used for determination is not included within the temperature range WR used for monitoring.

Conversely, under a situation in which the battery 14 is carried indoors, since the temperature (the indoor standby temperature 102) of the battery 14 decreases rapidly, at a timing (a point in time td shown in FIG. 11) that is earlier than in the situation in which the battery 14 is left outdoors, the indoor standby temperature 102 passes within the temperature range threshold value Tr. Consequently, the determination processing unit 72 uses the temperature of the battery 14 after time td as the detection temperature 102j used for determination. In this case, although the detection temperature 102j used for determination immediately after the point in time td is in excess of the temperature range WR used for monitoring, if the battery 14 is appropriately stored indoors, within a short elapsed time period, the detection temperature 102j used for determination enters within the temperature range WR used for monitoring. Accordingly, after the point in time td, the determination processing unit 72 determines that the detection temperature 102j used for determination is included within the temperature range WR used for monitoring. Stated otherwise, within a certain time period, accompanying the detection temperature 102j used for determination entering within the temperature range WR used for monitoring, the detection temperature 102j used for determination may be considered to have entered into the temperature range WR used for monitoring over the entirety of the initial period.

Further, after the detection temperature 102j used for determination has entered temporarily within the temperature range WR used for monitoring, the determination processing unit 72 performs the same processing as that of the first embodiment. Stated otherwise, during the period of non-usage, in the case that the detection temperature 102j used for determination is included at all times in the temperature range WR used for monitoring, the incentive information of the battery DB 78 is updated by adding, in relation to that battery 14, the period during which the detection temperature 102j used for determination was included in the temperature range WR used for monitoring.

Moreover, even in the second embodiment, in the case that the battery 14 is charged indoors, the determination processing unit 72 may be configured in a manner so as to cause the temperature range threshold value Tr to be changed. Stated otherwise, in the case that the determination processing unit 72 has extracted the fact that the battery 14 is in the charging period, the determination processing unit 72 widens the temperature range threshold value Tr for the charging period to be wider than the temperature range threshold value Tr for the non-charging period (for example, adding a tolerance value ±3° C. to the outdoor environmental temperature ET). In accordance with this feature, during charging of the battery 14, the determination processing unit 72 is capable of hastening the timing at which the temperature during non-usage becomes less than or equal to the temperature range threshold value Tr, or stated otherwise, the completion of excluding the initial period (starting of the determination detection period). Therefore, even in the case that the battery 14 is being charged indoors, it becomes possible to extract the detection temperature used for determination more rapidly in comparison with non-charging.

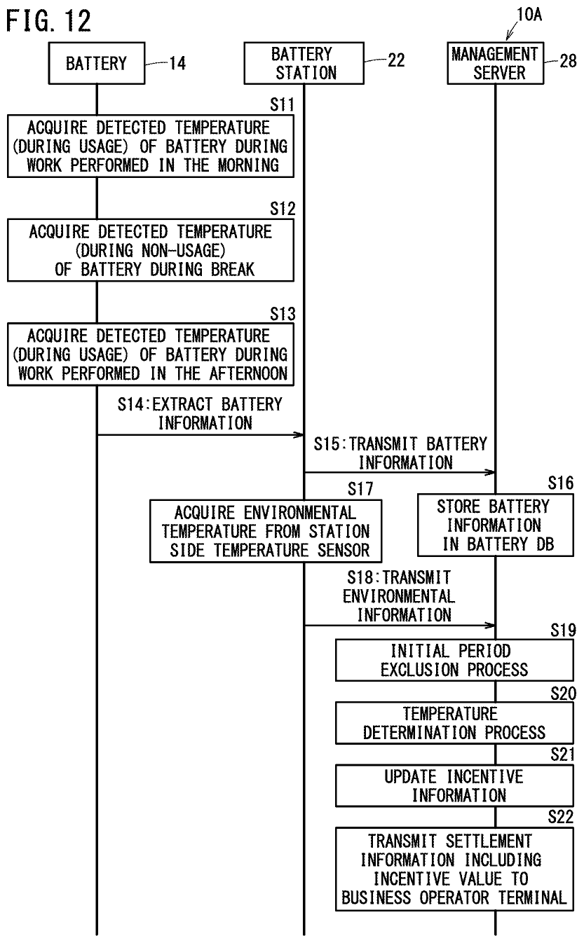

The temperature monitoring device 10A according to the second embodiment is basically configured in the manner described above. Hereinafter, a description will be given in detail concerning operations of the temperature monitoring device 10A. In this case, in the sharing system 12A, as shown in FIG. 12, step S11 to step S16 carry out the same processing as that of the process of steps S1 to S6 according to the first embodiment.

In addition, the rental control unit 38 (the station side acquisition unit 47) of the battery station 22 periodically acquires the outdoor environmental temperature ET from the station side temperature sensor 40, and stores the outdoor environmental temperature ET in the station side storage unit 48 as environmental information with which the time is associated (step S17). In addition, the rental control unit 38 transmits the environmental information to the management server 28 based on a request from the management server 28 (step S18).

Concerning the temperature during non-usage of the battery 14, on the basis of the temperature information (time-series data of the temperature and the time) and the outdoor environmental information acquired from the station side temperature sensor 40, the determination processing unit 72 carries out the initial period exclusion process to exclude the initial period from the time when usage is completed (step S19). The battery station 22 having the station side temperature sensor 40 is often provided in a position in close proximity to the location where the battery 14 is rented from or returned to the battery station 22, and the environmental temperature ET obtained from the station side temperature sensor 40 can be regarded as approximating the temperature of the location where the battery 14 is used. Thus, there is no need to provide a temperature sensor for the purpose of detecting the environmental temperature in each of the batteries 14, and the sharing system 12 can be configured in a simple manner. The initial period exclusion process, in the manner described above, sets the temperature range threshold value Tr based on the outdoor environmental temperature ET, and monitors the timing at which the temperature of the battery 14 during non-usage thereof passes within the temperature range threshold value Tr.

Next, during non-usage, the determination processing unit 72 carries out the temperature determination process to extract the detected temperatures 100j and 102j used for determination during the period (the determination detection period) after the temperature of the battery 14 has passed through the temperature range threshold value Tr, and to determine whether or not the extracted detection temperatures 100j and 102j used for determination are included within the temperature range WR used for monitoring (step S20). Consequently, in the case that the detection temperature 102j used for determination is included within the temperature range WR used for monitoring, a determination is made that the battery 14 has been appropriately stored by the user U (refer to FIG. 11). Conversely, in the case that the detection temperature 100j used for determination is outside of the temperature range WR used for monitoring, a determination is made that the battery 14 has not been appropriately stored by the user U (refer to FIG. 11).

Further, step S21 and step S22 are the same as the processes of step S9 and step S10 according to the first embodiment. More specifically, the determination processing unit 72 adds the period in which the detection temperature 102j used for determination is included within the temperature range WR as an incentive period, and updates the incentive information in the battery DB 78. By transmitting the settlement information that includes the incentive value to the business operator terminal 26, the terminal output information generating unit 74 can present to the user U a service in which the incentive is provided.

### Third Embodiment

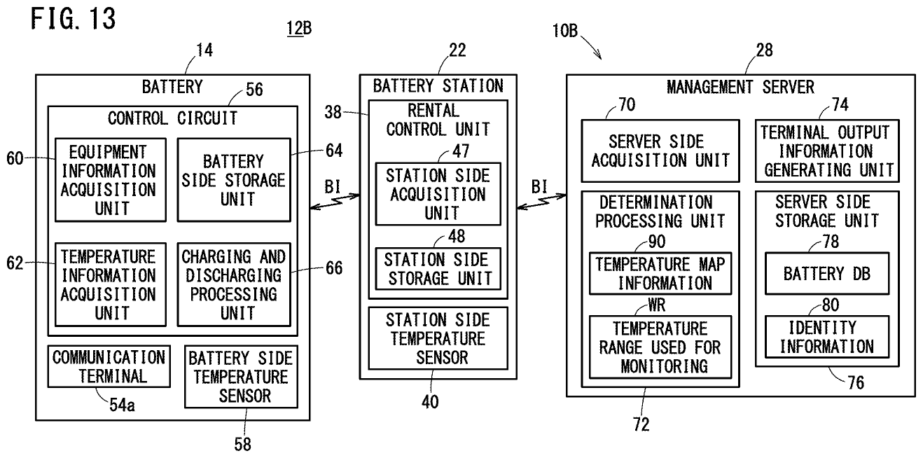

Next, a description will be given concerning the configuration of a temperature monitoring device 10B (a sharing system 12B) according to a third embodiment. As shown in FIG. 13, the temperature monitoring device 10B according to the third embodiment differs from the temperature monitoring device 10A according to the second embodiment, in that, when the outdoor environmental temperature is acquired from the battery station 22 (the station side temperature sensor 40), the time threshold value Tt for omitting the initial period during non-usage is set by referring to temperature map information 90.

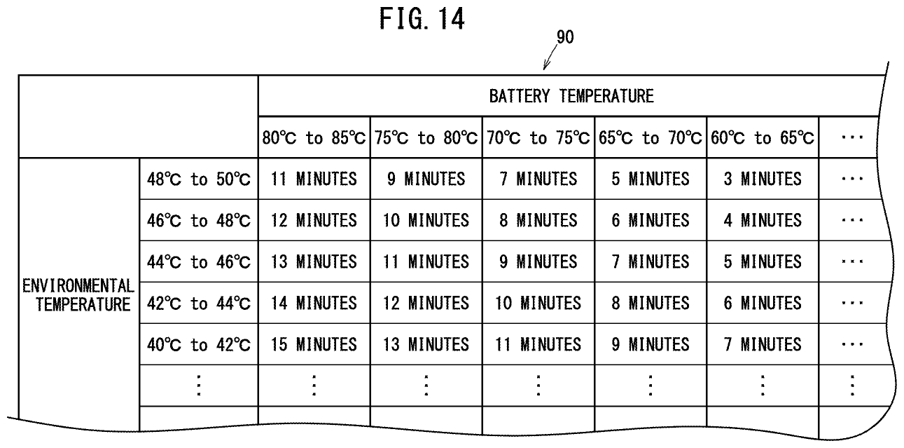

As shown in FIG. 14, the temperature map information 90 is provided in a table in which the temperature of the battery 14 and the outdoor environmental temperature at the starting time of non-usage are associated with each other by the time threshold value Tt. For example, the time threshold value Tt of the temperature map information 90 is set by experiment or simulation to determine how the temperature of the battery 14 changes for each of respective predetermined ranges of the outdoor environmental temperatures, or stated otherwise, the time period until the temperature of the battery 14 at the starting time of non-usage becomes a temperature equivalent to the outdoor environmental temperature. Moreover, it is a matter of course that the partitioning of the temperature of the battery 14 and the partitioning of the environmental temperature in the temperature map information 90 can be arbitrarily set.

The determination processing unit 72 of the management server 28 reads out the battery information BI and the environmental information that are acquired from the battery station 22 in the initial period exclusion process, together with reading out the temperature map information 90. In addition, the determination processing unit 72 extracts an appropriate time threshold value Tt from the temperature map information 90, based on the temperature of the battery 14 at the starting time of non-usage, and the outdoor environmental temperature at the starting time of non-usage. For example, taking the temperature map information 90 shown in FIG. 14 as an example, in the case that the temperature of the battery 14 is 72° C. and the outdoor environmental temperature is 41° C., the determination processing unit 72 extracts the time threshold value Tt of 11 minutes (the time period required until the temperature of the battery 14 decreases from 72° C. to become 41° C., which is the outdoor environmental temperature).

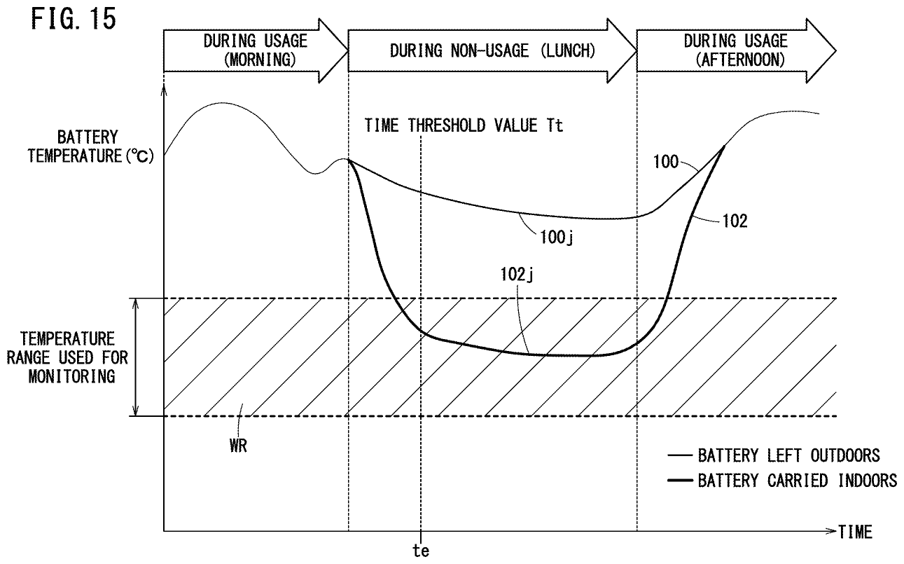

As shown in FIG. 15, when the time threshold value Tt is extracted, the determination processing unit 72 sets a point in time te by adding the time threshold value Tt to the starting time of non-usage. In addition, the determination processing unit 72 recognizes the temperature of the battery 14 from non-usage until the point in time te as the temperature at the initial period during non-usage, and does not include the temperature in the detection temperatures 100j and 102j used for determination.

In this instance, in a situation in which the battery 14 is left outdoors during non-usage thereof, at a timing after the point in time te has elapsed, the temperature of the battery 14 (the outdoor standby temperature 100) approaches toward the outdoor environmental temperature. Thus, in the non-usage period after the point in time te (the determination detection period), the detection temperature 100j used for determination changes in a substantially constant manner along with the outdoor environmental temperature. Therefore, in the case that the battery 14 is left outdoors, the detection temperature 100j used for determination becomes in excess of the temperature range WR (15° C. to 30° C.) used for monitoring, and the determination processing unit 72 determines that the detection temperature 100j used for determination is not included within the temperature range WR used for monitoring over the entirety of the period during non-usage.

Conversely, under a situation in which the battery 14 is carried indoors, since the temperature of the battery 14 (the indoor standby temperature 102) decreases rapidly, at a timing after the point in time te has elapsed, the indoor standby temperature 102 is much lower than the outdoor environmental temperature. Consequently, after the point in time te, the detection temperature 102j used for determination enters within the temperature range WR used for monitoring, and the determination processing unit 72 determines that the detection temperature 102j used for determination after the point in time te is included within the temperature range WR used for monitoring.

Further, after the detection temperature 102j used for determination has entered temporarily within the temperature range WR used for monitoring, the determination processing unit 72 performs the same processing as that of the first embodiment. Stated otherwise, during the period of non-usage, in the case that the detection temperature 102j used for determination is included at all times in the temperature range WR used for monitoring, the incentive information of the battery DB 78 is updated by adding, in relation to that battery 14, the period during which the detection temperature 102j used for determination was included in the temperature range WR used for monitoring.

Moreover, even in the third embodiment, in the case that the battery 14 is charged indoors, the determination processing unit 72 may be configured in a manner so as to cause the time threshold value Tt to be changed. As one example thereof, in the case that the determination processing unit 72 has extracted the fact that the battery 14 is in the charging period, the determination processing unit 72 makes the charging period time threshold value Tt shorter than the time threshold value Tt at the time of non-charging (for example, −5 minutes is added to the time threshold value Tt). Consequently, during charging of the battery 14, it is possible to shorten the initial period. Even in the case that the battery is charged indoors, the determination processing unit 72 becomes capable of extracting the detection temperature 102j used for determination more rapidly in comparison with non-charging of the battery 14.

The sharing system 12B according to the third embodiment is basically configured in the manner described above. In the sharing system 12B, a process flow is executed that is basically the same as the process flow of the sharing system 12A according to the second embodiment shown in FIG. 12.

However, in the initial period exclusion process (step S19 in FIG. 12), the determination processing unit 72 refers to the temperature map information 90 as described above, and extracts the time threshold value Tt, and based on the time threshold value Tt, carries out a process to omit the initial period from the starting time of non-usage. Additionally, the determination processing unit 72 extracts the detected temperatures 100j and 102j used for determination during the period after the time threshold value Tt has been extracted from the starting time of non-usage, and in the temperature determination process, determines whether or not the detection temperatures 100j and 102j used for determination are included within the temperature range WR used for monitoring.

Consequently, in the case that the detection temperature 102j used for determination is included within the temperature range WR used for monitoring, a determination is made that the battery 14 has been appropriately stored by the user U. Conversely, in the case that the detection temperature 100j used for determination is outside of the temperature range WR used for monitoring, a determination is made that the battery 14 has not been appropriately stored by the user U. The determination processing unit 72 adds the period in which the detection temperature 102j used for determination is included within the temperature range WR as an incentive period, and updates the incentive information in the battery DB 78. By transmitting the settlement information that includes the incentive value to the business operator terminal 26, the terminal output information generating unit 74 can present to the user U a service in which the incentive is provided.

Moreover, it should be noted that the initial period exclusion process in which the initial period during non-usage of the battery 14 is excluded is not limited to carrying out the above-described first to third embodiments separately, and the embodiments may be combined in a plurality. For example, in the case that both (or either one) of the first predetermined condition for comparing the rate of change T in the temperature during non-usage and the rate of change threshold value Tc, and the second predetermined condition of comparing the temperature during non-usage and the temperature range threshold value Tr are satisfied, the temperature from the starting time of non-usage until the conditions are satisfied may be excluded.

A description will be given below concerning the technical concepts and advantageous effects that are capable of being grasped from the above-described embodiments.

One aspect of the present invention is characterized by the temperature monitoring device 10, 10A, or 10B (the management server 28) that monitors the temperature of the battery 14 that is configured to be attached to and detached from the equipment 16, including the acquisition unit (the server side acquisition unit 70) configured to acquire the temperature of the battery 14 during non-usage after having carried out discharging to the equipment 16, and the determination processing unit 72 configured to perform the temperature determination process in order to determine whether or not the temperature during the non-usage lies within the predetermined temperature range (the temperature range WR used for monitoring), wherein the determination processing unit 72 excludes, from being a target of the temperature determination process, the temperature of the battery 14, in an initial period from the starting time of the non-usage until the predetermined condition is satisfied.

In accordance with the aforementioned features, by excluding the initial period in which the battery 14, the temperature of which has risen accompanying discharging of electricity to the equipment 16, from being a target of the temperature determination process, the temperature monitoring device 10, 10A, or 10B (the management server 28) is capable of carrying out the temperature determination process in accordance with temperature information that the user U can more easily understand. Consequently, the temperature monitoring device 10, 10A, or 10B can prompt the user U to be made aware of the temperature management of the battery 14 during non-usage thereof, and it becomes possible to suppress deterioration of the battery 14. In particular, if the temperature monitoring system 10, 10A, 10B is the sharing system 12 or the like that manages a large number of the batteries 14, the operating cost can be significantly reduced by suppressing the degradation of the batteries 14.

Further, the acquisition unit (the server side acquisition unit 70) acquires the temperature during usage while discharging to the equipment 16 is being carried out and the temperature during the non-usage of the battery 14, the temperature monitoring device 10, 10A, or 10B (the management server 28) manages, as the identity information 80 in association with the acquired temperature of the battery 14, at least one piece of information of the battery identification information in order to identify the battery 14, the user identification information in order to identify the user U who has used the battery 14, or the equipment identification information in order to identify the equipment 16 in which the battery 14 is installed, and the determination processing unit 72 stores in association with each other, using the identity information 80, the temperature during the first usage in which discharging prior to the non-usage was carried out, the temperature during the non-usage, and the temperature during a second usage in which discharging after the non-usage was carried out. In accordance with such features, the temperature monitoring device 10, 10A, or 10B, at a time during usage prior to and after non-usage can track the usage of the same battery 14 or the same equipment 16, whereby, since it is possible to grasp the temperature management condition of the user U under a condition in which it is likely to be left outdoors during non-usage thereof, it becomes possible to provide with respect to the user U an incentive in which satisfaction is higher.

Further, the predetermined condition is satisfied in the case that the rate of change T of the temperature during the non-usage is less than or equal to the rate of change threshold value Tc. Consequently, the temperature monitoring device 10 (the management server 28) can more reliably exclude the time required for heat to be dissipated from the battery 14 whose temperature has increased accompanying usage thereof.

Further, in the case that the battery 14 is charged during the non-usage of the battery 14, the acquisition unit (the server side acquisition unit 70) is configured to acquire the charging information concerning the charging, and the determination processing unit 72 increases the rate of change threshold value Tc based on recognition of the charging information. Consequently, the temperature monitoring device 10 can accurately exclude the initial period with respect to the battery 14 that is charged during non-usage thereof.

The acquisition unit (the server side acquisition unit 70) is configured to acquire the outdoor environmental temperature ET at the starting time of the non-usage, and the predetermined condition is satisfied in the case that the temperature of the battery 14 during the non-usage has surpassed the temperature range threshold value Tr, which is set based on the acquired outdoor environmental temperature ET at the starting time of the non-usage. In this case as well, the temperature monitoring device 10A (the management server 28) can more reliably exclude the time required for heat to be dissipated from the battery 14 whose temperature has increased accompanying usage thereof.

Further, the acquisition unit (the server side acquisition unit 70) is configured to acquire the outdoor environmental temperature ET at the starting time of the non-usage from the temperature sensor (the station side temperature sensor 40) provided in the charging device (the battery station 22) for the battery 14. Since it can be considered to detect the temperature at a position in close proximity to the location where the battery 14 is used, the station side temperature sensor 40 does not require a temperature sensor in order to detect the environmental temperature ET in each of the batteries 14, and the sharing system 12 can be configured in a simple manner.

In the case that the battery 14 is charged during the non-usage of the battery 14, the acquisition unit (the server side acquisition unit 70) is configured to acquire the charging information concerning the charging, and the determination processing unit 72 widens the temperature range threshold value Tr based on recognition of the charging information. Even in the case that the temperature range threshold value Tr is used, the temperature monitoring device 10A (the management server 28) can accurately exclude the initial period with respect to the battery 14 that is charged during non-usage thereof.

Further, the acquisition unit (the server side acquisition unit 70) is configured to acquire the outdoor environmental temperature ET at the starting time of the non-usage of the battery 14, and the predetermined condition is satisfied in the case that the time threshold value Tt has elapsed, which is set based on the acquired outdoor environmental temperature ET at the starting time of the non-usage, and the temperature of the battery 14 at the starting time of the non-usage. In this case as well, the temperature monitoring device 10B (the management server 28) can more reliably exclude the time required for heat to be dissipated from the battery 14 whose temperature has increased accompanying usage thereof.

Further, in the case that the battery 14 is charged during the non-usage of the battery 14, the acquisition unit (the server side acquisition unit 70) is configured to acquire the charging information concerning the charging, and the determination processing unit 72 shortens the time threshold value Tt based on recognition of the charging information. Even in the case that the time threshold value Tt is included, the temperature monitoring device 10B (the management server 28) can accurately exclude the initial period with respect to the battery 14 that is charged during non-usage thereof.

Further, the acquisition unit (the server side acquisition unit 70) is configured to acquire the outdoor environmental temperature ET, and the determination processing unit 72 sets the predetermined temperature range (the temperature range WR used for monitoring) on the basis of the acquired environmental temperature ET. In accordance with this feature, by bringing about a change in the temperature range of an incentive provision in accordance with the environmental temperature, the temperature monitoring device 10, 10A, or 10B (the management server 28) is capable of enhancing the satisfaction of the user U.

1. A temperature monitoring device comprising one or more processors that execute computer-executable instructions stored in a memory, wherein the one or more processors execute the computer-executable instructions to cause the temperature monitoring device to:
monitor a temperature of a battery that is configured to be attached to and detached from equipment;
acquire a temperature of the battery during non-usage after having carried out discharging to the equipment;
perform a temperature determination process in order to determine whether or not the temperature during the non-usage lies within a predetermined temperature range; and
exclude from being a target of the temperature determination process, the temperature of the battery in an initial period from a starting time of the non-usage until a predetermined condition is satisfied.

2. The temperature monitoring device according to claim 1, wherein the one or more processors execute the computer-executable instructions to cause the temperature monitoring device to:
acquire a temperature during usage while discharging to the equipment is being carried out and the temperature during the non-usage of the battery;
manage, as identity information in association with an acquired temperature of the battery, at least one piece of information of battery identification information in order to identify the battery, user identification information in order to identify a user who has used the battery, or equipment identification information in order to identify the equipment in which the battery is installed; and
store in association with each other, using the identity information, a temperature during a first usage in which discharging prior to the non-usage was carried out, a temperature during the non-usage, and a temperature during a second usage in which discharging after the non-usage was carried out.

3. The temperature monitoring device according to claim 1, wherein the predetermined condition is satisfied in a case that a rate of change of the temperature during the non-usage is less than or equal to a rate of change threshold value.

4. The temperature management device according to claim 3, wherein the one or more processors execute the computer-executable instructions to cause the temperature monitoring device to:
in a case that the battery is charged during the non-usage of the battery, acquire charging information concerning charging; and
increase the rate of change threshold value based on recognition of the charging information.

5. The temperature management device according to claim 1, wherein the one or more processors execute the computer-executable instructions to cause the temperature monitoring device to:
acquire an outdoor environmental temperature at the starting time of the non-usage; and
the predetermined condition is satisfied in a case that the temperature of the battery during the non-usage has surpassed a temperature range threshold value, which is set based on an acquired outdoor environmental temperature at the starting time of the non-usage.

6. The temperature management device according to claim 5, wherein the one or more processors execute the computer-executable instructions to cause the temperature monitoring device to acquire the outdoor environmental temperature at the starting time of the non-usage from a temperature sensor provided in a charging device for the battery.

7. The temperature management device according to claim 5, wherein the one or more processors execute the computer-executable instructions to cause the temperature monitoring device to:
in an case that the battery is charged during the non-usage of the battery, acquire charging information concerning charging; and
widen the temperature range threshold value based on recognition of the charging information.

8. The temperature management device according to claim 1,
wherein the one or more processors execute the computer-executable instructions to cause the temperature monitoring device to acquire an outdoor environmental temperature at the starting time of the non-usage of the battery; and
the predetermined condition is satisfied in a case that a time threshold value has elapsed, which is set based on the acquired outdoor environmental temperature at the starting time of the non-usage, and the temperature of the battery at the starting time of the non-usage.

9. The temperature management device according to claim 8, wherein the one or more processors execute the computer-executable instructions to cause the temperature monitoring device to:
in a case that the battery is charged during the non-usage of the battery, acquire charging information concerning charging; and
shorten the time threshold value based on recognition of the charging information.

10. The temperature management device according to claim 1, wherein the one or more processors execute the computer-executable instructions to cause the temperature monitoring device to:
acquire an outdoor environmental temperature; and
set the predetermined temperature range on a basis of an acquired environmental temperature.
